(19) United States
(12) Patent Application Publication
(10) Pub. No.: US 2010/0212842 A1
(43) Pub. Date: Aug. 26, 2010

(54) Roller blind and member therefore

(76) Inventor: Peter Bichler, Munchen (DE)

Correspondence Address: CHRISTINE JOHNSON ESQ., 151 Trenton Rd., Fairless Hills, PA, 19030, US

(21) Appl. No.: 12/389,632

(22) Filed: Feb. 20, 2009

(51) Int. Cl. E06B 9/08

(52) U.S. Cl. 160/133

(57) ABSTRACT

A member (4) for a Venetian-blind action roller blind, comprises a bar (8, 8′, 8″) and a slat (9, 9′, 9″) which are connected together at a first hinge (7) in such a way as to be able to pivot, and which have respective outer hooks (5, 6; 5′, 6′; 5″, 6″), the outer hook (5, 5′, 5″) of the slat (9, 9′, 9″) being arranged to form, with the outer hook (6, 6′, 6″) of the bar (8, 8′, 8″) of an identical second member (4), a second hinge. The slat also carries two inner hooks (10, 11; 10′, 11′, 10″, 11″) curved in opposite respective directions of which the first (10, 10′, 10″) engages in a recess (15) in an inner hook (12, 12′, 12″) of the bar and the second (11, 11′, 11″) extends round an outer side of the inner hook (12, 12′, 12″) of the bar. The inner hooks (10, 11; 10′, 11′; 10″, 11″) of the slat (9, 9′, 9″) have arcuate, concentric surfaces whose common centre is an axis of pivot (27, 27′, 27″) of the first hinge (7).

The present invention relates to a roller blind for shading a window in a building and to a roller blind member of which a plurality can be joined together to form a roller blind of this kind.

Most conventional roller blinds are composed of a plurality of mutually identical members which are intrinsically stiff and which are guided at their two longitudinal ends, with a certain amount of play, in respective rails, which means that, when they are lowered to shade a window, they touch a boundary created by the rail on only one side, or the roller blind apron which they form extends along an oscillating path between the boundaries created by the rail with a wavelength which is considerably longer than the height of the roller blind members. In both cases a moderate wind speed is enough to cause parts of the roller blind to swing back and forth between the boundaries, and the roller blind thus makes flapping noises which are a nuisance.

In strong winds, the roller blind members may bow and be pulled out of the rails. The tendency for this to happen is all the greater the wider is the roller blind. Roller blind members for wide windows therefore need to have a structure which is stiff in bending, which structure can only be produced at high cost.

A roller blind has become known from DE 10 2004 048 251 A1 whose members each comprise a bar and a slat which is connected to the bar to be able to pivot. In a roller blind of this kind, when it is in the fully lowered state, a slat has the weight of whichever slats are situated above it resting on it, and because of this it is caused to pivot relative to its member and in so doing to position itself obliquely in a guide rail. Because the slat is touching both boundaries created by the guide rail at the same time, a high ability to withstand wind loads on the part of the roller blind is obtained.

The bars of this known roller blind are each provided with apertures which, in a freely suspended position in which the slats are each loaded in tension, are covered by the slats, whereas in the state where they are loaded in compression and are in a obliquely positioned state, the slats expose the apertures in the bars and fresh air, but not sunlight, is able to pass through the roller blind.

A roller blind member as defined in the preamble to claim 1 is known from DE 1 237 289 B1. In this roller blind, the bars which connect the slats together in such a way that the latter can pivot are reduced to mutually separate intermediate members of small width which have a joint-forming head around which hooks of the slat fit. The joint-forming head has two grooves in which the hooks alternately engage as the slat pivots.

Both to allow the roller blind members to wedge between the boundaries created by the guide rail and also where there are bars provided with apertures to enable the ventilating effect to be obtained, it is necessary for the bars and slats to pivot easily and reliably relative to one another when, as the roller blind is lowered, its bottom end hits a window sill or some other stop. At the same time, the connecting joint between the bar and the slat must be robust to prevent a burglar from being able to take the connection between the bars and slats apart and in this way break open the roller blind.

It is an object of the present invention to specify a member for a roller blind, and a roller blind apron which uses such a member, which meet these requirements with great reliability.

In accordance with the invention, provision is made, in a member for a roller blind which has a bar and a slat which are connected together at a first hinge in such a way as to be able to pivot, and which have respective outer hooks, the outer hook of the slat being arranged to form, with the outer hook of the bar of an identical second member, a second hinge, for the slat to carry two inner hooks curved in opposite respective directions of which the first engages in an inner hook of the bar and the second extends round an outer side of the inner hook of the bar. In this way, the inner hook of the bar, and the first inner hook of the slat, which engages therein, form the parts of the first hinge which are essential for a pivotable connection, while the second inner hook restricts the abilities of the bar and slat to move relative to one another purely to a pivoting movement and stops the hooks from unintentionally becoming detached from one another. Arcuate, concentric surfaces of the inner hooks of the slat whose common centre is the axis of pivot of the first hinge ensure that the pivoting movement is accurately guided.

If the axis of pivot extends along a corner of the bar and/or the slat, the first hinge can be made able to pivot with particular freedom and hence particular reliability.

An arcuate form for the recess in the inner hook of the bar also contributes to the freedom of movement of the hinge.

In a preferred embodiment, the bar is provided with at least one aperture, and the slat is able to pivot between a first abutting position in which a pivoting flap of the slat rests against the bar in such a way as to close off the aperture, and a second abutting position in which the pivoting flap is splayed away from the aperture to enable fresh air to pass through when the roller blind is in the lowered state.

In another preferred embodiment, the slat does not have a pivoting flap and the bar does not have any apertures. The principal function of the slat is then to position itself obliquely in the rail guiding the roller blind when the latter is lowered, so that the bar and slat of a roller blind member fill the rail without allowing any play. On the one hand the oblique position of the slat considerably increases the stiffness of the roller blind member and on the other hand the fact that the member is held in the rail without any play stops the member from beginning to swing, which considerably increases the ability of the roller blind to withstand wind loads and makes it possible for extremely wide roller blinds to be constructed.

To locate adjacent members, or the bar and slat of a member, relative to one another in the longitudinal direction, at least one of the hooks which extend in a web-like form in the longitudinal direction of the member is interrupted for part of its length, and a tongue belonging to another hook which, with the one hook, forms the first or second hinge engages in the interruption.

The tongue is preferably cut free from one of the inner hooks of the slat and is bent into the interruption. This is particularly advantageous when the slat is made of a plastically deformable metal, and preferably of aluminium, but the web is made from a material which loses strength as a result of being deformed, such as say a thermoplastic plastics material.

It is also useful if the bar comprises a first profile which forms the outer hook of the bar and an intermediate piece which is joined to the first profile. By making this intermediate piece, in which apertures in the bar are preferably formed, from a different material from the first profile, it is possible to save on the cost of materials. The first profile, which is visible from a weather side of the roller blind at least when the pivoting flap is in the splayed apart position, may in particular be composed of the same material as the slat, whereas a more economical material can be used for the intermediate part, which is hidden.

To optimise the ability to bear mechanical loads, the inner hook too of the bar may be produced on a profile, a second one, which is joined to the intermediate piece.

The invention also relates to a roller blind apron having at least one first and one second member as defined above, in which the outer hook of the slat of the first member and the outer hook of the bar of the second member are connected to form the second hinge.

To ensure that the roller blind apron will wedge reliably in the lowered state and that the pivoting flaps will splay apart, the slat and bars of the members are preferably able to pivot between a first and a second abutting position, the distance between the axes of the second hinges of a member being larger in the first abutting position than in the second abutting position and the distance between the axis of the first hinge and a line connecting the axes of the two second hinges being smaller in the first abutting position than in the second abutting position.

To give the roller blind strength in the lowered state, it is also useful for the bar of each member to have a supporting face which is substantially horizontal in the installed orientation, and for a section of the slat to rest on the supporting face in the second abutting position.

Also acting to strengthen the roller blind apron is the fact that a fin on the bar of the second member is supported on the section in the second abutting position.

For strengthening purposes, a free end of the second inner hook of the slat may also be supported on a shoulder on the bar.

To encourage reliable pivoting movement of the slats, the outer hook of the bar of the second member preferably has a horizontal section, and in the second abutting position the outer hook of the slat of the first member preferably touches the upper side of this horizontal section.

In a variant embodiment, the slat has at least one aperture which is open in the first abutting position and closed off by a bar in the second abutting position. In this way, the roller blind apron is substantially completely light-tight and wind-tight in its fully lowered position; shortly before the fully lowered position is reached, a certain exchange of air is possible, instead, through the roller blind apron.

Further features and advantages of the invention can be seen from the following description of embodiments, which is given by reference to the accompanying drawings. In the drawings:

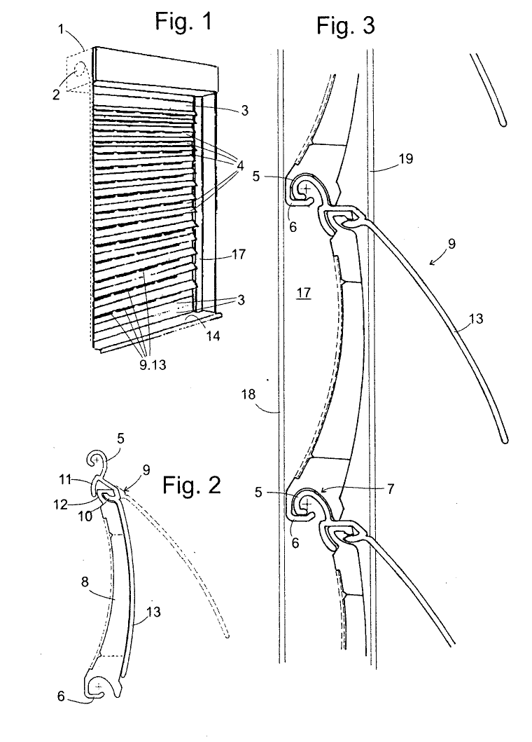

FIG. 1 is a schematic view of a window in a building which is fitted with a roller blind which forms a first embodiment of the invention.

FIG. 2 is a section through a member of the roller blind shown in FIG. 1 in a suspended but not fully lowered state.

FIG. 3 is a section through members of the roller blind shown in FIG. 1 in a fully lowered state.

FIG. 4 is an enlarged section through the roller blind members which are interengaged by hinges, in the suspended state.

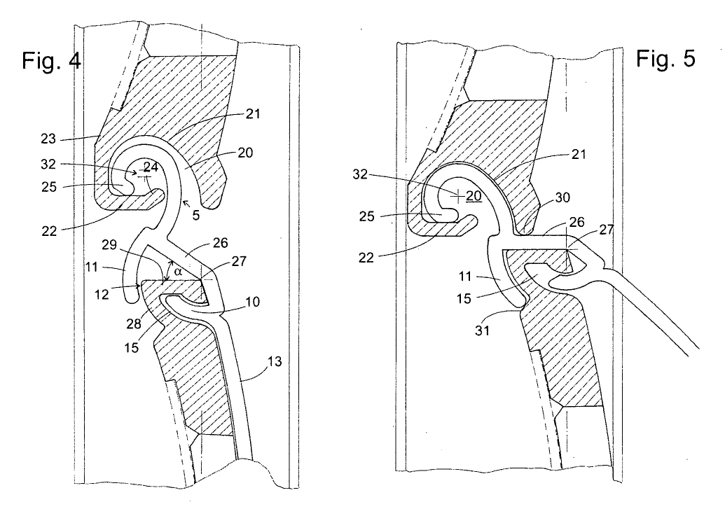

FIG. 5 is a section similar to FIG. 4 showing the fully lowered state.

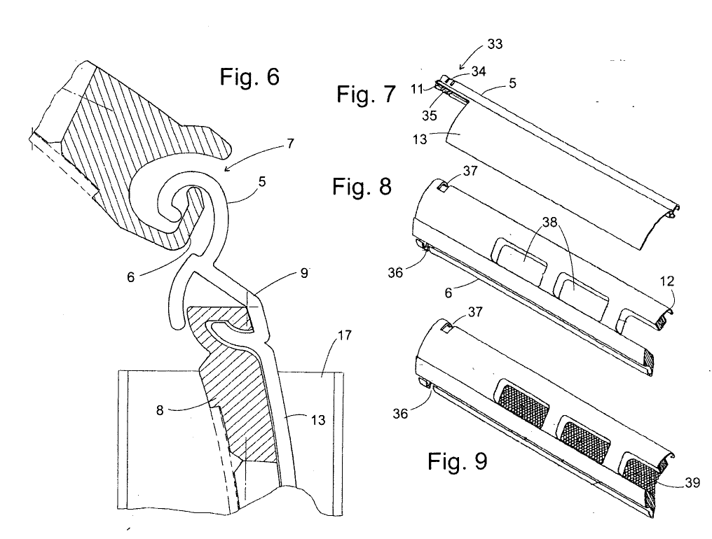

FIG. 6 is a section similar to FIG. 4 through members of the roller blind when in the rolled-up state.

FIG. 7 is a perspective view of a slat of a member of the first embodiment of the roller blind.

FIG. 8 is a view similar to FIG. 7 of a bar of the roller blind member.

FIG. 9 is a perspective view of a modified bar.

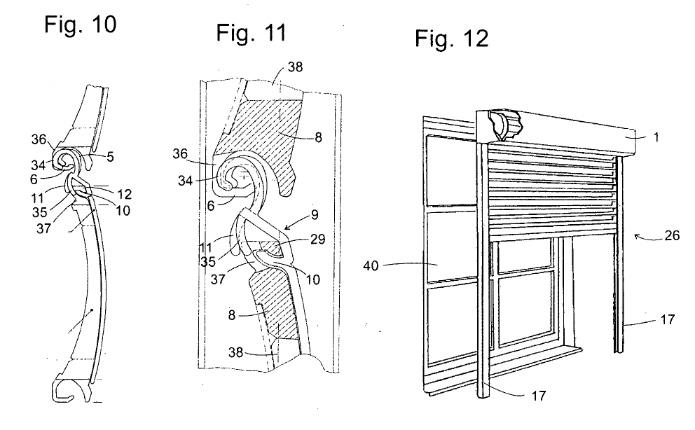

FIG. 10 is a section through a roller blind member to show the locking of the members to one another in the longitudinal direction.

FIG. 11 is a section similar to Fig.10 which shows a modified type of longitudinal locking.

FIG. 12 is a schematic view of a window which has a roller blind which forms a second embodiment of the invention.

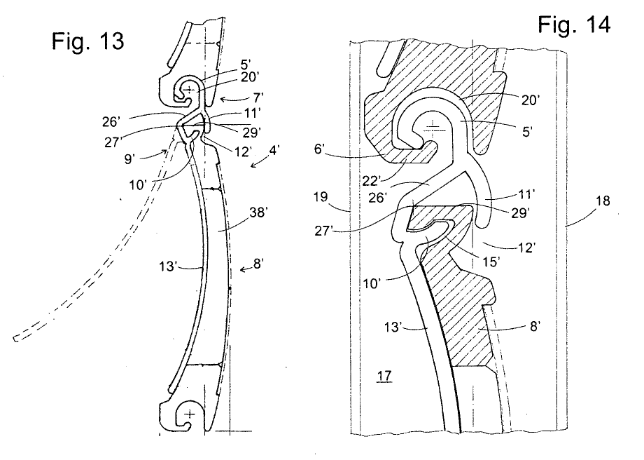

FIG. 13 is a section through members of the roller blind shown in FIG. 12.

FIG. 14 is an enlarged section through hinges of the roller blind shown in FIG. 12 when in a suspended state.

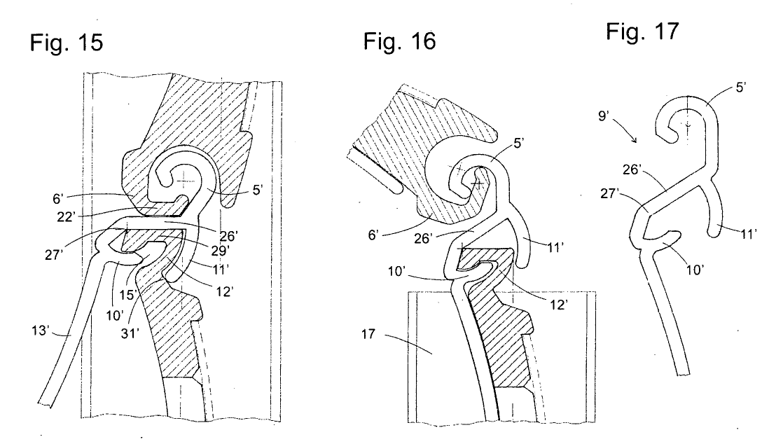

FIG. 15 is a section similar to FIG. 14 showing a fully lowered state.

FIG. 16 is a section through members of the roller blind shown in FIG. 12 when in the rolled-up state.

FIG. 17 is a section through a slat in a modified embodiment.

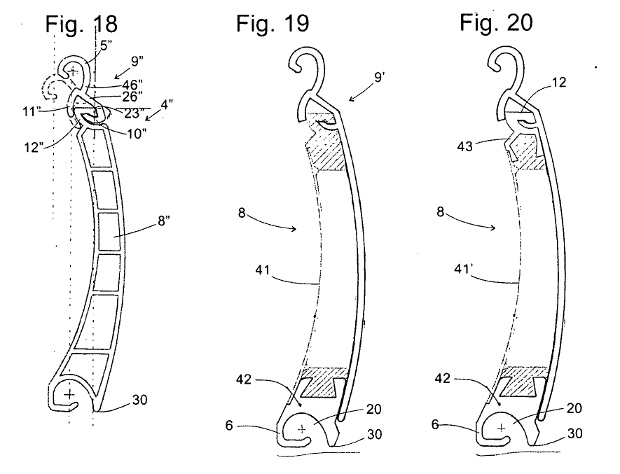

FIG. 18 is a section through a roller blind member in a third embodiment of the invention.

FIG. 19 shows a roller blind member having a bar which is joined together from a plurality of parts.

FIG. 20 shows a second roller blind member having a bar which is joined together from a plurality of parts.

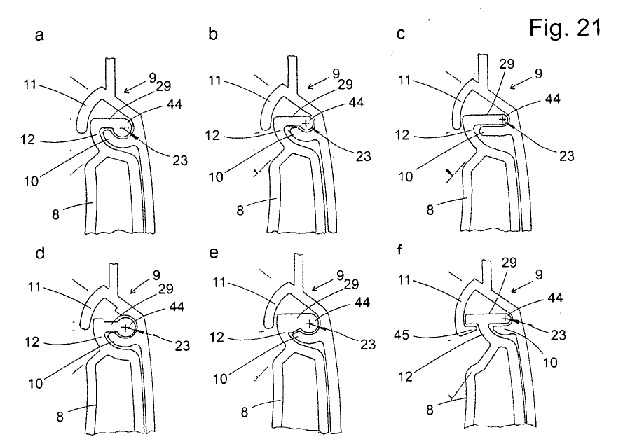

FIG. 21 shows modifications of the cross-section of the first hinge of the roller blind members.

FIG. 1 is a schematic view of a roller blind according to the invention when installed in a window in a building. A roller blind box 1 which is recessed into the wall of the building and which is not visible from outside is indicated in broken lines. A box which was inserted in a pocket in the window opening could also be provided instead of the recessed roller blind box 1. Situated in the roller blind box 1 is a winding roller 2 of cylindrical or square cross-section which is rotatable to enable the roller blind apron, which is shown fully lowered in FIG. 1, to be wound up and drawn into the roller blind box 1.

The roller blind apron comprises a plurality of members 3, 4. The members 3, which respectively form a top and a bottom terminal part of the apron, may be bars in the form of hollow profiles of a kind known per se which are extruded in one piece from plastics material or aluminium. What may also be considered as an alternative (not shown in the drawing) are bars which are cut from sheet aluminium and folded into a hollow body, and which are filled with foamed material to stiffen them if required. The members 3 are preferably of a construction which will be described at a later point by reference to FIG. 18.

As is shown in the cross-sections in FIGS. 2 and 3 by taking the members 4 as an example, the members 3, 4 have at their top and bottom edges hooks 5, 6 which will be referred to below as outer hooks, which hooks 5, 6 extend in a web-like form for the entire length of the members 3, 4 and engage in one another to form a hinge 7 between adjoining members 3, 4. The number of interconnected members 3 which form the top terminal part of the roller blind apron is so selected that when, as shown in FIG. 1, the apron is fully lowered and is supported on a window sill 14, one of the member 3 projects from the roller blind box 1.

Connected to this final one-piece member 3 are two-piece members 4 whose construction can also be seen from FIG. 2. Each two-piece member 4 comprises a slat 9, which carries the outer hook 5 and two inner hooks 10, 11 and which, like the outer hook 5, extend in a web-like form for the entire length of the slat 9, and a bar 8, which carries the outer hook 6 at its bottom edge and an inner hook 12 at its top edge, the inner hook 12 forming a recess 15 in which the inner hook 10 of the slat 9 engages in such a way as to be able to pivot.

When the member 4 is stressed in tension, the slat 9 assumes a position in which a pivoting flap 13 of the slat rests against an outer face of the bar 8 and covers a major proportion thereof, as shown by the outline in solid lines in FIG. 2. In the event of the member 4 being loaded in compression, when the roller blind has been lowered, the slat 9 pivots, and the pivoting flap 13 thus assumes a position, shown in broken lines in FIG. 2, in which it is splayed away from the outer face of the bar 8.

This state is shown more clearly in FIG. 3, which is a section through a plurality of bars 8 which are guided laterally in a U-shaped guide rail 17 on or in the window frame. The hooks 6 each rest against a side-wall 18 of the guide rail 17 which is adjacent the glass of the window; an edge (which will be explained in greater detail by reference to FIG. 7) of the slat 9 touches an outer side-wall 19 of the guide rail 17, and the individual members of the roller blind apron are thus held in the guide-rail without any play.

The fact that the members 4 are held between the side-walls 18, 19 without any play considerably improves the ability of the roller blind to withstand wind loads but does not interfere with the mobility of the roller blind members when the roller blind apron is being drawn up and lowered because it is only in the fully lowered state in which the members 4 are loaded in compression that their slats 9 assume the configuration shown in FIG. 3. In the state where they are loaded in tension, the amount of space that the members 4 need between the side walls 18, 19 is smaller and there is thus no danger of the roller blind apron jamming.

The form of the interengaging hooks 5, 6, 10 to 12 and the way in which they operate will be explained in greater detail by reference to the enlarged views shown in FIGS. 4 to 6. FIG. 4 shows the hooks 5, 6, 10, 11, 12 of two successive roller blind members 4 in the suspended state in which the members 4 are guided between the side walls 18, 19 of the rail 17. The hook 6 partly closes off a groove 20 which is formed in the bottom edge of the bar 8, which groove 20 is bounded in the upward direction by a wall surface 21 which follows an evenly curved path. The hook 6 comprises a substantially horizontal section 22 which forms an extension of a rear wall 23 of the bar 8 and which merges at its front edge into a web 24 which is directed obliquely upwards.

The outer hook 5 of the slat 9, which outer hook 5 engages in the groove 20, follows a curved path complementary to that of the wall surface 21 for a predominant part of its length and has a bent-up tip 25 which extends in a straight line. The hook 5 starts from a straight section 26 which merges at one edge, at a sharp kink extending along an axis 27, into the pivoting flap 13 and which carries the inner hook 11 at its other edge. The hook 11 is in the form of a sector of a circle in cross-section, the centre of the circle coinciding with the axis 27.

The inner hook 10, which extends from the pivoting flap 13 in the opposite direction from the hook 11 is, like the latter, in the shape of an arc of a circle, this arc having the axis 27 as its centre and being of a smaller radius than that of the hook 11.

The inner hook 12 of the bar 8 likewise comprises a portion 28 in the form of an arc of a circle, which arc is centred on the axis 27 and has a radius which is between those of the hooks 10 and 11, which portion 28 carries a substantially horizontal section 29 which angles off at a sharp angle. A sharp edge is likewise formed along the axis 27 on the section 29.

The angle α which is made between the sections 26, 29 determines the freedom to move by pivoting of the slat 9 between the suspended configuration shown in FIG. 3 and the lowered configuration shown in FIG. 4. It is 35° in the present case.

In the lowered configuration shown in FIG. 4, the tip 25 has point support on the horizontal section 22 of the hook 6, and the inner hook 10 engages in a recess 15 which is formed by the hook 12 right to the end thereof. The weight of the bar 8 thus rests in essence on the hook 10. Because the hook 11 overlaps the arcuate section 28 of the hook 12, it is not possible for the bar 8 to be detached from the slat 9 without the hook 11 being destroyed. Because the latter is in a protected position on the inside of the roller blind and the hook 12 is not accessible from outside either, it is difficult to separate the members of the roller blind according to the invention from one another, once they have been correctly installed in a window.

The axis 27 defines a pivot point for the pivoting movement of the slat 9 from the suspended configuration shown in FIG. 4 to the fully lowered configuration shown in FIG. 5. In this latter configuration, the section 26 of the slat 9 rests flat against the horizontal section 29 of the lower bar 8 and a bottom fin 30 on the upper bar 8 is supported in turn on the section 26. The upper bar 8 is supported in addition by the fact that the bottom end of the hook 11 comes into abutment against a shoulder 31 on the lower bar 8. An abutting position of the hinge 7 is defined by the fact that the outer hook 5 is nestling against the wall surface 21 of the groove 20 for a major proportion of its length and the tip 25 is resting against the horizontal section 22 of the hook 6 over an area.

Because the axis of pivot 27 of the hinge formed by the hooks 10 to 12 is positioned at two interengaging corners of the bar 8 and slat 9, the surfaces of the bar 8 and slat 9 which rub against one another when the slat 9 pivots are reduced to a minimum; the pivoting movement of the slat 9 is therefore very free and reliable. It will readily be appreciated that the axis of pivot 32 of the hinge 7 formed by the hooks 5, 6 likewise performs a pivoting movement about the axis 27 as the transition to the fully lowered configuration takes place, which means that, in the fully lowered configuration, the distance between the respective axes 27 and 32 of adjoining roller blind members is smaller in the lowered state than in the suspended configuration, but the distance between the planes which are respectively defined by the axes 32 and 27 of successive members 4 is larger than in the suspended configuration.

FIG. 6 shows the hinges between two roller blind members 4 in the wound-up state within the roller blind box 1. In this configuration, the pivoting flap 13 rests flat against the outer side of the bar 8, and the external outline of the member 4 thus does not differ in any major way from that of a conventional one-piece roller blind member. The members are therefore able to pivot relative to one another at the hinge 7 and can be rolled up like a conventional roller blind.

FIG. 7 is a perspective view of part of the slat 9. It can be seen that the pivoting flap 13 does not extend right to that end 33 of the slat which engages in the guide rail 17. It is only the hooks 5, 10, 11 and the section 26 which extend as far as this end. Tongues 34 and 35 are cut free from the hooks 5 and 11 respectively in the end portion 33. These tongues 34, 35 are provided to enable the said tongues 34, once the slat 9 has been assembled to the bar shown in FIG. 8 by sliding it along the hooks 10-12 in the longitudinal direction, to be bent into an interruption 36 in the hook 6 and an interruption 37 in the hook 12 respectively and thus to enable the bars 8 and slats 9 to be locked to one another in the longitudinal direction.

The tongues 34, 35 and interruptions 36, 37 are provided in each case at only one of the two opposite end portions 33 of the slat 9 and bar 8 respectively to ensure that, if the two latter are made of different materials, different coefficients of thermal expansion will not result in the roller blind members bending.

What can also be seen in FIG. 8 are apertures 38 which are cut in the bar 8, through which fresh air is able to pass through the roller blind when it is in the fully lowered configuration where the pivoting flaps 13 are splayed away from the bar 8. The position of these apertures 38 in the bar 8, the angle a, and the length of the pivoting flap 13 are matched to one another in such a way that the bottom edge of the pivoting flap 13 is situated on a level with the bottom edge of the apertures 38 in the splayed-away position. Although fresh air is easily able to pass through the roller blind in this way, any direct transmission of sunlight is ruled out. Alternatively, the bottom edge of the pivoting flap 13 may also be situated slightly above the bottom edge of the apertures 38 when splayed away to enable sunlight to pass through directly at twilight and early morning.

The said apertures 38 may, if desired, also be closed off by an anti-insect mesh 39, which can for example be done by means of a strip of net material which is continuous over all the apertures 38 in the bar or at least a majority of them and which is stuck to the back of the bar 8 (see FIG. 9).

FIG. 10 shows the longitudinal locking by means of the tongues 34, 35 and interruptions 36, 37 in the form of a cross-section taken at the point where the interruptions 36, 37 are situated. The tongue 34 has been deflected towards the building in comparison with the rest of hook 5 from which it was cut free, and the tongue 34 thus projects beyond the hook 5 surrounding it. In a corresponding way, the hook 12 has been pressed outwards to a point of abutment formed by the tip of the hook 11 in order in this way to overlap the section 28 of the hook 12. The hook 12 has been completely cut away at the point where the tongue 35 is situated; however, as the alternative view in FIG. 11 shows, it may be enough for the interruption to be made merely in the arcuate section 28 of the hook 12 and for the horizontal section 29 of the latter to be left untouched, at least for part of its width.

FIG. 12 is a perspective view similar to FIG. 1 of a window 40 in a building which has, fitted in front of it, a second embodiment of roller blind according to the invention which is guided in guide rails 17. In this case the roller blind box 1′ is not recessed into the wall of the building but is positioned in front of it, which means that the direction of curvature in which the roller blind apron is rolled up in the box 1′ is different from that shown in FIG. 1. The members of a roller blind of this kind, which is also referred to as an anti-clockwise rolling roller blind, are generally of concave curvature on their weather side, unlike those of the clockwise rolling blind which was described by reference to FIGS. 1 to 11, which are convex on their weather side.

FIG. 13 is a section through a two-piece member 4′ of a roller blind of this kind, which is assembled from a slat 9′ and a bar 8′ which are hingeably interengaged. As in the case of FIG. 1, the roller blind apron may also have conventional one-piece members at its top and bottom ends in addition to the two-piece members 4′. The construction of a hinge 7′ which connects the members of the roller blind is similar to that in the roller blind shown in FIGS. 1 to 12; a groove 20′ in the bottom edge of the bar 8′ is partly closed off by a horizontal section 22′ of an outer hook 6′ of the bar, which section 22′ starts from a concave outer side of the bar. In contrast to the case shown in FIG. 1, this concave outer side is the weather side. A straight section 26′ of the slat 9′ connects the inner hook 5′ of the slat 9, which inner hook 5′ engages in the groove 20′, and its inner hook 11′ to an axis of pivot 27′ about which the slat 9′ is able to pivot relative to its associated bar 8′. The inner hook 12′ of the bar 8′ has an arcuate outer side, which is concentric with the axis 27′ and across which the hook 11′ moves as pivoting takes place, and an arcuate inner surface, which defines a recess 15′ in which the hook 10′ is guided. In this case too, a pivoting flap 13′ of the slat 9′ rests against the weather side of the bar 8′ in the suspended state, whereas in the fully lowered state in which there is loading in compression the pivoting flap 13′ is splayed away from the bar 8′ and exposes apertures 38′ in the bar.

FIGS. 14, 15 and 16 are enlarged views of the interengaging hooks 5′, 6′, 10′ to 12′, showing them in the suspended state, in the fully lowered state, and in the rolled-up state respectively. In the fully lowered state shown in FIG. 15, the straight section 26′ is clamped between the horizontal section 22′ of the bar situated above it and the horizontal section 29′ of the bar situated below it. The tip of the hook 11′ is supported on a shoulder 31′ on the bar 8′ situated below it. The roller blind apron is held between the side walls 18, 19 of the rails 17 without any play because the convex outer side of each of the bars 8′ rests against the side wall 18 and a foot region of each of the hooks 10′ rests against the side wall 19.

FIG. 17 shows a slightly modified variant of the slat 9′ in cross-section. Whereas in the slat 9′ shown in FIGS. 13 to 16 the hooks 5′ and 11′ meet substantially at the same point at the edge of the straight section 26′, in the embodiment shown in FIG. 17 the section 26′ is widened slightly beyond the foot of the hook 11′, which means that at the transition to the fully lowered state the load exerted by the roller blind members situated above the slat 9′, which presses on the hook 5′, generates a higher turning moment about the axis 27′ and the slot 9′ is thus able to pivot more easily and reliably.

FIG. 18 is a cross-section through a clockwise-rolling roller blind member 4″ in a third embodiment of the invention. The slat 9″ of this roller blind member differs from that shown in FIGS. 1 to 11 in essence only in that there is no pivoting flap 13 and the bar 8″ which is pivotably connected to the slat 9″ does not have any apertures. The ventilating effect which existed in the fully lowered state with the embodiments described above is thus done away with. The importance of the slat 9″ lies, in this case, in the fact that its pivoting makes it possible, in the way which has already been explained by reference to the first embodiment, for the fully lowered roller blind apron to be wedged in its guide rails and for any flapping to be stopped from happening in this way.

To allow a ventilating effect to be obtained in a not fully lowered state in which the slat 9″ is loaded in tension, slots may be cut in the hook 5″ close to its foot at a point which is indicated by reference numeral 46″, or the straight section 26″ and the hook 11″ may have local interruptions.

An anti-clockwise rolling roller blind similar to the embodiment shown in FIG. 18 can be obtained by omitting the apertures 38′ in the bar 8′ and the pivoting flap 13′ on the slat 9′ from each of the embodiments shown in FIGS. 13 to 17.

The roller blind members described above may be made from various materials by using different techniques. Whereas both extrusion as hollow profiles from plastics material, and for small dimensions even extrusion as solid profiles from plastics material or metal, and roll forming from sheet metal, possibly followed by filling with foam of the internal cavity which is produced by roll forming, may be considered for the bars, what is generally preferred for the slats is extrusion from metal. To obtain a similar appearance for the bars and slats when different materials are used, the slats may be given a paint finish matched to the surface of the bars; it is however also conceivable for the slats to be left with the metal surface which they already have, because they do after all form the major proportion of the surface of the roller blind apron which is visible on the weather side.

To provide a roller blind apron which is of a completely metallic appearance on the weather side, bars 8 which are joined together from a plurality of parts, such as are shown for example in FIGS. 19 and 20, may be used. In FIG. 19, the bar 8 is joined together from two parts, namely a main part 41 which is extruded from plastics material, and a bottom edge profile 42 of metal which forms the groove 20 and the outer hook 6 plus the fin 30 which projects on the weather side below the pivoting flap 13. The main part 41 and edge profile 42 are held together by positive interengagement, by a dovetail shape in the present case.

Higher load-bearing capacity can be achieved if not only the outer hook 6 of the bar is part of a metal profile, but the inner hook 12 too is part of a metal profile 43 which is joined to a main part 41′ of plastics material, as shown in FIG. 20.

Finally, FIG. 21 shows a selection of alternative cross-sectional forms for the inner hooks 10, 11, 12. What all these variants have in common is that the axis of pivot 27 extends concentrically through a tip 44 of the hook 12 which is in the form of a sector of a cylinder. If the diameter of this tip 44 is larger than the wall thickness of the horizontal section 29 of the hook 12 from which it continues, this will help to stiffen the hook but it does also increase the friction which occurs between the bar 8 and slat 9 in the course of pivoting. The tip of the hook 11 may be provided with an inwardly directed barb 45 which, as shown in FIG. 21f, fits behind the horizontal section 29. It is true that a barb 45 of this kind increases the stiffness of the hook 11, but on the other hand it also makes it necessary for the hook 10 to be shortened and its positive guidance in the recess 15 in the hook 12 to be abandoned, which again reduces load-bearing capacity and security against break-ins.

1. Member (4) for a Venetian-blind action roller blind, having a bar (8, 8′, 8″) and a slat (9, 9′, 9″) which are connected together at a first hinge in such a way as to be able to pivot, and which have respective outer hooks (5, 6; 5′, 6′; 5″, 6″), the outer hook (5, 5′, 5″) of the slat (9, 9′, 9″) being arranged to form, with the outer hook (6, 6′, 6″) of the bar (8, 8′, 8″) of an identical second member (4), a second hinge (7), and the slat carrying two inner hooks (10, 11; 10′, 11′, 10″, 11″) curved in opposite respective directions of which, to form the first hinge, the first (10, 10′, 10″) engages in a recess (15) in an inner hook (12, 12′, 12″) of the bar and the second (11, 11′, 11″) extends round an outer side of the inner hook (12, 12′, 12″) of the bar, characterised in that the inner hooks (10, 11; 10′, 11′; 10″, 11″) of the slat (9, 9′, 9″) have arcuate, concentric surfaces whose common centre is an axis of pivot (27, 27′, 27″) of the first hinge (7).

2. Member according to claim 1, characterised in that the axis of pivot (27, 27′, 27″) extends along a corner of the bar (8, 8′, 8″) and/or the slat (9, 9′, 9″).

3. Member according to claim 1, characterised in that the recess (15) is arcuate.

4. Member according to claim 1, characterised in that the bar (8, 8′) is provided with at least one aperture (38, 38′), and in that the slat (9, 9′) is able to pivot between a first abutting position in which a pivoting flap (13, 13′) of the slat rests against the bar (8, 8′) in such a way as to close off the aperture (38, 38′), and a second abutting position in which the pivoting flap (13, 13′) is splayed away from the aperture (38, 38′).

5. Member according to claim 1, characterised in that the bar (8, 8′) and the slat (9, 9′) have a freedom of movement ( ) relative to one another in pivot of between 20° and 50°, and preferably of between 30° and 45°.

6. Member according to claim 1, characterised in that at least one of the hooks (5, 6, 10-12) which extends in a web-like form in the longitudinal direction of the member is interrupted for part of its length, and a tongue (34, 35) belonging to another hook (5, 11) which, with the one hook (6, 12), forms the first or second hinge (7) engages in the interruption (36, 36).

7. Member according to claim 6, characterised in that the tongue (34, 35) is cut free from one of the hooks (5, 11) of the slat (9) and is bent into the interruption (36, 37).

8. Member according to claim 1, characterised in that the bar (8) comprises a first profile (42) which forms the outer hook (6) of the bar (8) and an intermediate piece (41, 41′) which is joined to the first profile (42).

9. Member according to claim 8, characterised in that the inner hook (12) of the bar (8) is produced on a second profile (43) which is joined to the intermediate piece (41′).

10. Roller blind apron having at least one first and one second member (4) according to claim 1, characterised in that the outer hook (5, 5′, 5″) of the slat (9, 9′, 9″) of the first member and the outer hook (6, 6′, 6″) of the bar (8, 8′, 8″) of the second member are connected to form the second hinge.

11. Roller blind apron according to claim 10, characterised in that the slats (9, 9′, 9″) and bars (8, 8′, 8″) of the members are able to pivot between a first and a second abutting position, the distance between the axes (32) of the second hinges (7) of a member being larger in the first abutting position than in the second abutting position and the distance between the axis (27) of the first hinge and a line connecting the axes (32) of the two second hinges (7) being smaller in the first abutting position than in the second abutting position.

12. Roller blind apron according to claim 1 1, characterised in that the bar (8, 8′, 8″) of each member has a supporting face (29, 29′, 29″) which is substantially horizontal in the installed orientation, and in that a section (26, 26′, 26″) of the slat (9, 9′, 9″) rests on the supporting face (29, 29′, 29″) in the second abutting position.

13. Roller blind apron according to claim 12, characterised in that a fin (30) on the bar (8, 8′, 8″) of the second member is supported on the section (26, 26′, 26″) in the second abutting position.

14. Roller blind apron according to claim 11, characterised in that in the second abuting position a free end of the second inner hook (11, 11 ′) of the slat is supported on a shoulder (31, 31′) on the bar.

15. Roller blind apron according to claim 11, characterised in that the outer hook (6) of the bar (8) of the second member has a horizontal section (22), and in that in the second abutting position the outer hook (5) of the slat (9) of the first member preferably touches the upper side of the horizontal section (22).

16. Roller blind apron according to claim 11, characterised in that the slat (9″) has at least one aperture which is open in the first abutting position and closed off by a bar in the second abutting position.
